(19) United States
(12) Patent Application Publication
(10) Pub. No.: US 2018/0221242 A1
(43) Pub. Date: Aug. 9, 2018

(54) WHEELCHAIR SEAT CUSHION

(71) Applicant: Wai Leung LEE, Hong Kong (HK)

(72) Inventors: Wai Leung LEE, Hong Kong (HK); Ling Sun YIN, Hong Kong (HK)

(21) Appl. No.: 15/893,147

(22) Filed: Feb. 9, 2018

(30) Foreign Application Priority Data
Feb. 9, 2017 (HK) 17101470.8

(51) Int. Cl. A61H 39/06; A61G 5/10

(52) U.S. Cl. CPC A61H 39/06; A61G 5/1048; A61G 5/1045; A61G 2210/90; A61H 2201/164; A61H 2201/0161; A61H 2201/1623; A61H 2201/168; A61H 2201/0207

(57) ABSTRACT

A wheelchair seat cushion comprises a back pad module and a seat pad module which is connected with the back pad module. A resilient intermediate layer is provided within the back pad module and the seat pad module. A heat generating device is provided within in the resilient intermediate layer, wherein the heat generating device is positioned corresponding to at least one acupuncture point of a back of a user, and heat generated by the heat generating device is conducted to a body of the user via the at least one acupuncture point in order to keep the body of the user warm.

### FIELD OF THE INVENTION

The present invention relates to a seat cushion, in particular to a wheelchair seat cushion.

### BACKGROUND OF INVENTION

It is known that one wheelchair seat cushion has strong support force but has poor air permeability, with the result that heat dissipation is not good when a user sits on the wheelchair seat cushion. The other wheelchair seat cushion has high air permeability but has poor support, with the result that pressure exerted on the user is not able to be released when the user sits on the wheelchair seat cushion.

In addition, during the winter, the user, particularly elderly person, does less exercise. Even if the user put on clothes but he/she still feels cold. Also, when a wheelchair is not in use and needs to be folded, the wheelchair seat cushion is usually required to be removed before folding the wheelchair. It is not convenient to the user to put the wheelchair seat cushion back on the wheelchair for next time use.

### SUMMARY OF THE INVENTION

The present invention is to provide a foldable wheelchair seat cushion with strong support, high air permeability and heat generation. A wheelchair seat cushion comprises a back pad module and a seat pad module which is connected with the back pad module. A resilient intermediate layer is provided within the back pad module and the seat pad module. A heat generating device is provided within in the resilient intermediate layer, wherein the heat generating device is positioned corresponding to at least one acupuncture point of a back of a user, and heat generated by the heat generating device is conducted to a body of the user via the at least one acupuncture point in order to keep the body of the user warm.

Preferably, the back pad module and the seat pad module are connected via at least one flexible band. Surfaces of the back pad module and the seat pad module have a plurality of fold lines, by which the user folds the seat cushion and a wheelchair at the same time.

Preferably, the heat-generating device is positioned corresponding to Mingmen point and Shenshu point of the back of the user. The resilient intermediate layer is made of resin cotton so as to enhance support and air permeability of the wheelchair seat cushion. The back pad module has wing modules extending outwardly from both sides thereof respectively or the seat pad module has wing modules extending outwardly from both sides thereof respectively, to protect both chest sides of the user. The wing module is foldable about the side of the back pad module or the wing module is foldable about the side of the seat pad module.

Preferably, a heat generating device is disposed within in the seat pad cushion module to keep leg portions of the user warm. The wheelchair seat cushion further comprises a leg pad module attached to one side of the seat pad module opposite to the back pad module. A surface of the leg pad module is provided with a plurality of fold lines. The back pad module comprises at least one fastener to secure the back pad module on the wheelchair. The seat pad module comprises at least one fastener to secure the seat pad module on the wheelchair.

### DESCRIPTION OF THE DRAWINGS

The present invention will be further described with reference to the accompanying drawings and embodiments, in the accompanying drawings:

FIG. 1 is a schematic view of the wheelchair seat cushion according to one of the embodiments of the present invention;

FIG. 2 is a cross-sectional view of a wheelchair seat cushion of according to one of the embodiments of the present invention;

FIG. 3 is a schematic view of a wheelchair seat cushion on a wheelchair in a use configuration according to one of the embodiments of the present invention;

FIG. 4 is a schematic view of a wheelchair seat cushion on a wheelchair in a folded configuration according to one of the embodiments of the present invention;

FIG. 5 is a cross-sectional view of alternative embodiment of the wheelchair seat cushion of according to one of the embodiments of the present invention;

FIG. 6 is a schematic view of alternative embodiment of the wheelchair seat cushion on a wheelchair in a use configuration according to one of the embodiments of the present invention;

FIG. 7 is a schematic view of alternative embodiment of the wheelchair seat cushion on a wheelchair in a folded configuration according to one of the embodiments of the present invention.

### DETAILED DESCRIPTION

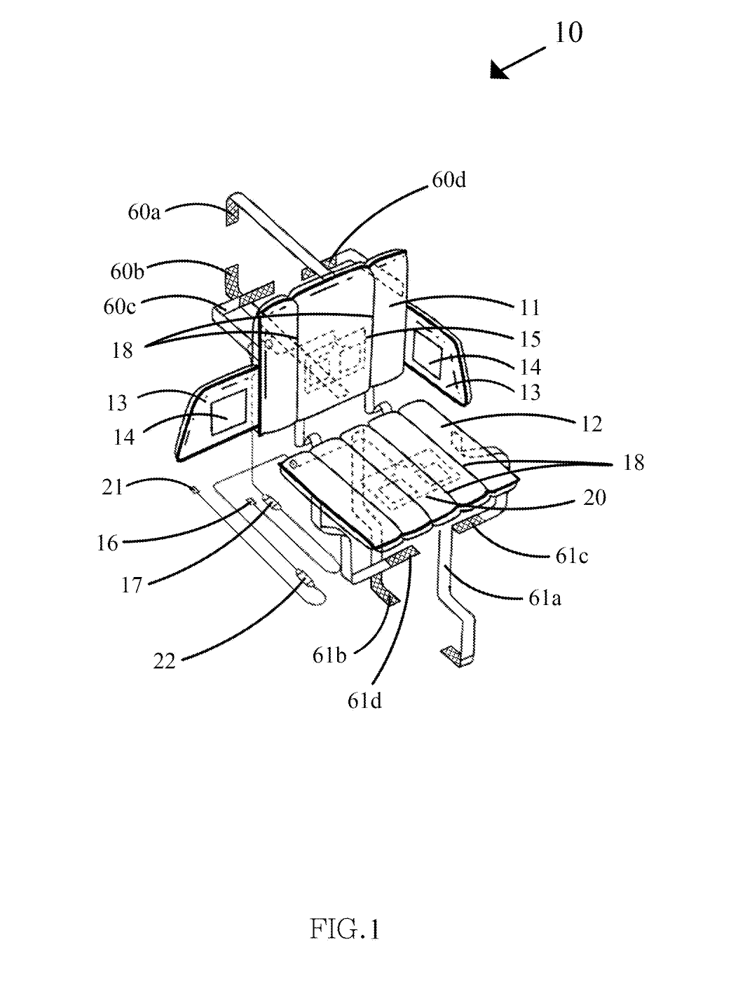

As shown in FIG. 1, wheelchair seat cushion 10, according to the present invention, comprises back pad module 11 and seat pad module 12. Back pad module 11 and seat pad module 12 are connected by at least one flexible connector, for example, two flexible bands 19. Back pad module 11 and seat pad module 12 are foldable relative to each other in order to facilitate a user to collect and carry wheelchair seat cushion 10.

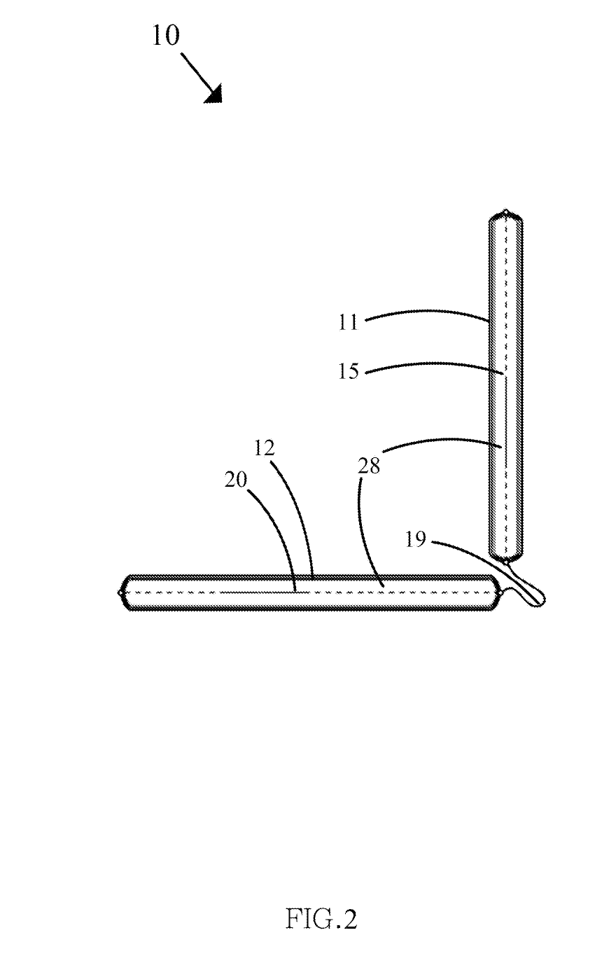

As shown in FIG. 2, back pad module 11 and seat pad module 12 are provided with resilient intermediate layer 28, which is made of a material with strong support and high air-permeability, such as resin cotton. Wing modules 13 extend outwardly from both sides of back pad module 11 respectively. Back pad module 11, seat pad module 12 and wing module 13 are respectively enclosed by a waterproof material, such as a nylon material, for easy cleaning. Wing module 13 is able to be folded about the side of the back pad module 11. When wing modules 13 are in a use configuration, they will be moved to positions adjacent to both chest sides of the user for protection. The wing module 13 is provided with bag 14 for the user to place personal items. A plurality of fold lines 18 are provided on surfaces of back pad module 11 and seat pad module 12 respective Wing module 13 may have different shapes, such as trapezoid.

Heat generating device 15 is provided within in resilient intermediate layer 28 of back pad module 111 and is positioned at a lower portion of back pad module 11 for supplying heat to a back of the user. Heat generating device 15 is provided with thermostat 17 and power port 16. Power port 16 is connected with external power supply for bringing power to heat generating device 15. Thermostat 17 controls temperature of heat generating device 15 and also is able to operate as a switch to power on/off heat generating device 15. Alternatively, a physical switch may be used for powering on/off heat generating device 15. In one embodiment, heat generating device 15 is positioned corresponding to at least one acupuncture point of a back of a user, for example Mingmen point and Shenshu point located at the back of the user.

In one embodiment, thigh portions of the user are sensitive, heat generating device 20 is provided within in resilient intermediate layer 28 of seat pad module 12 for supplying heat to the thigh portions of the user. Heat generating device 20 is positioned corresponding to thigh portions close to knees of the user. Heat generating device 20 is provided with thermostat 22 and power port 21. Power port 21 is connected with external power supply for bringing power to heat generating device 20. Thermostat 22 controls temperature of heat generating device 20 and also is able to operate as a switch to power on/off heat generating device 20. Alternatively, a physical switch may be used for powering on/off heat generating device 20.

At least one fastener is provided with back pad module 11 and at least one fastener is provided with seat pad module 12. In one embodiment, fasteners 60a, 60b, 60c and 60d, for example, hooks and loops, are provided at front end, rear end, and both sides of back pad module 11 respectively. Fasteners 61a, 61b, 61c and 61d, for example, hooks and loops, are provided at front end, rear end, and both sides of seat pad module 12 respectively. Fasteners 60a, 60b, 60c and 60d are used to secure back pad module 11 on wheelchair 40 and fasteners 61a, 61b, 61c and 61d are used to secure seat pad module 12 on wheelchair 40.

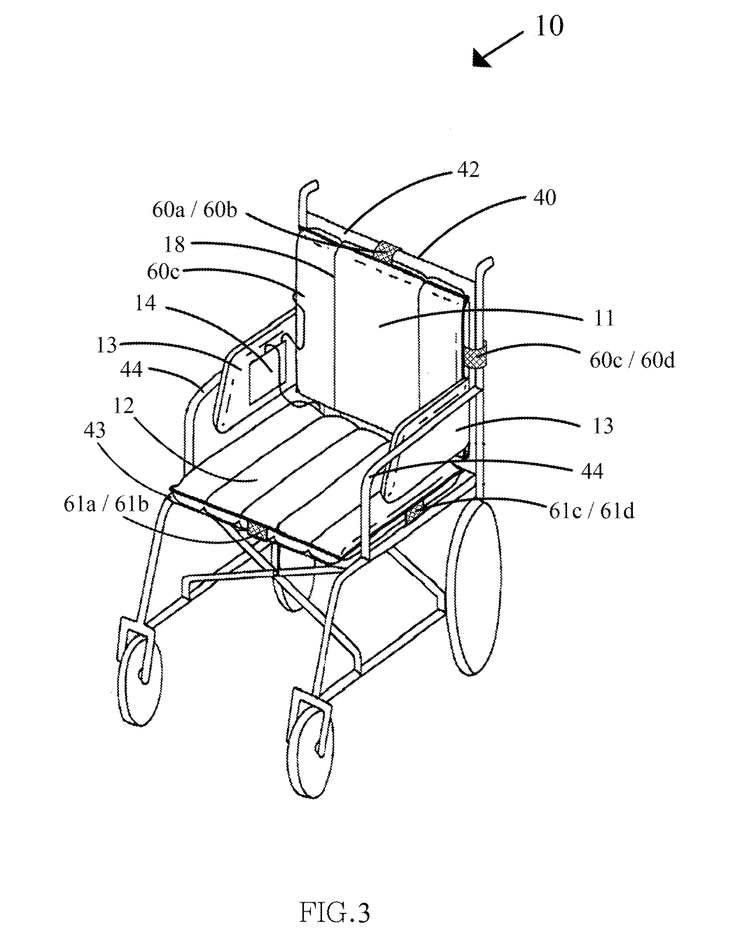

FIG. 3 shows that wheelchair seat cushion 10 is secured on wheelchair 40 in a use configuration. In one embodiment, fasteners 60a and 60b are fixedly attached to each other and also fasteners 60c and 60c are fixedly attached to each other in order to secure back pad module 11 onto back frame 42 of wheelchair 40. Similarly, fasteners 61a and 61b are fixedly attached to each other and also fasteners 61c and 61c are fixedly attached to each other in order to secure seat pad module 12 onto seat frame 43 of wheelchair 40.

In one embodiment, during wheelchair 40 is used on a road, particularly the road with a rough surface, shock resulted from the rough surface is absorbed by the user, particularly both chest sides of the user due to poor body stability of the user or leaning the body of the user on handle portions 44 of wheelchair 40. Wing modules 13 are adapted to protect both chest sides of the user when the user sits on wheelchair seat cushion 10 secured onto wheelchair 40 and the wheelchair is in motion.

Most of the users of wheelchair 40 are elderly people. Due to lack of exercise, the elderly people have poor blood circulation. In winter, even when elderly people put on many clothes, the elderly people remain feeling cool because of poor blood circulation. When elderly people use wheelchair seat cushion 10, the temperature of heat generating device 15 is adjusted to be close to body temperature of the user via thermostat 17. Heat generated by heat generating device 15 is allowed to be conducted to the body of the user via Mingmen point and Shenshu point located at the back of the user. Blood circulation of the user will be regulated upon Mingmen point and Shenshu point are warmed up, with the result that the user will get warmer.

Heat generated by heat generating device 20 is allowed to be conducted to the thigh portions of the user in order to keep the thigh portions of the user warm. Temperature of heat-generating device 20 is able to be controlled by thermostat 22.

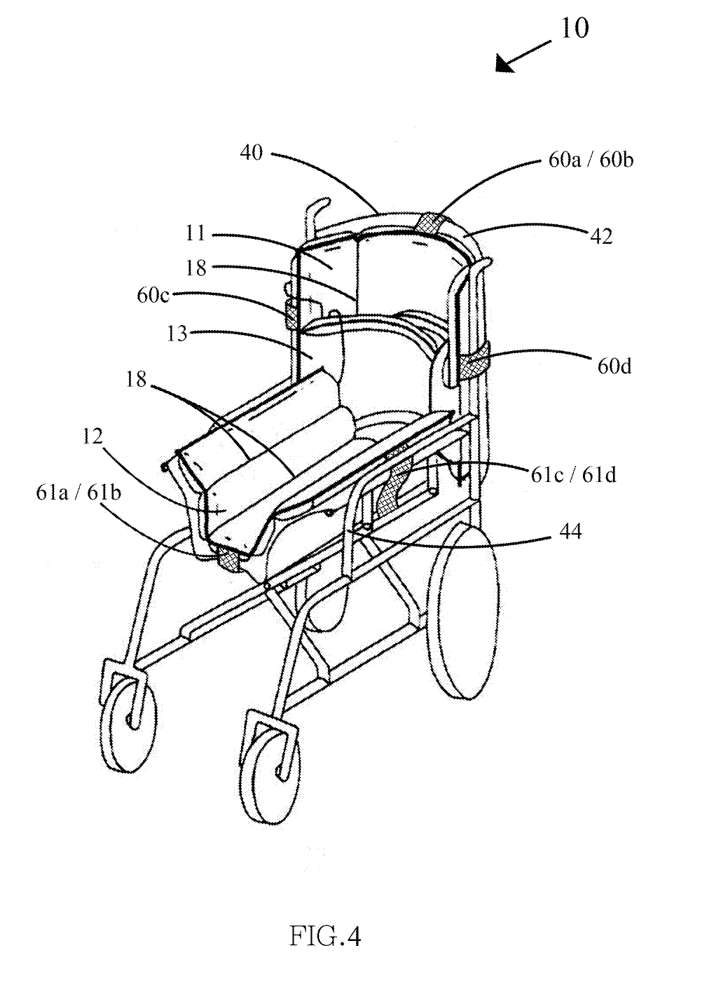

FIG. 4 illustrates that wheelchair 40 with wheelchair seat cushion 10 is in a folded configuration. In one embodiment, a plurality of fold lines 18 are provided on surfaces of back cushion module 11 and seat pad module 12 respectively. If the user does not use wheelchair 40, he may wish to fold wheelchair 40 to reduce size of wheelchair 40 in order to save more space. While wheelchair 40 is being folded, back cushion module 11 and seat pad module 12 are concurrently being folded via the plurality of fold lines 18. One of the benefits is to allowing the user to tidy up wheelchair 40 and wheelchair seat cushion 10 at the same time, instead of removing wheelchair seat cushion 10 and then folding wheelchair 40.

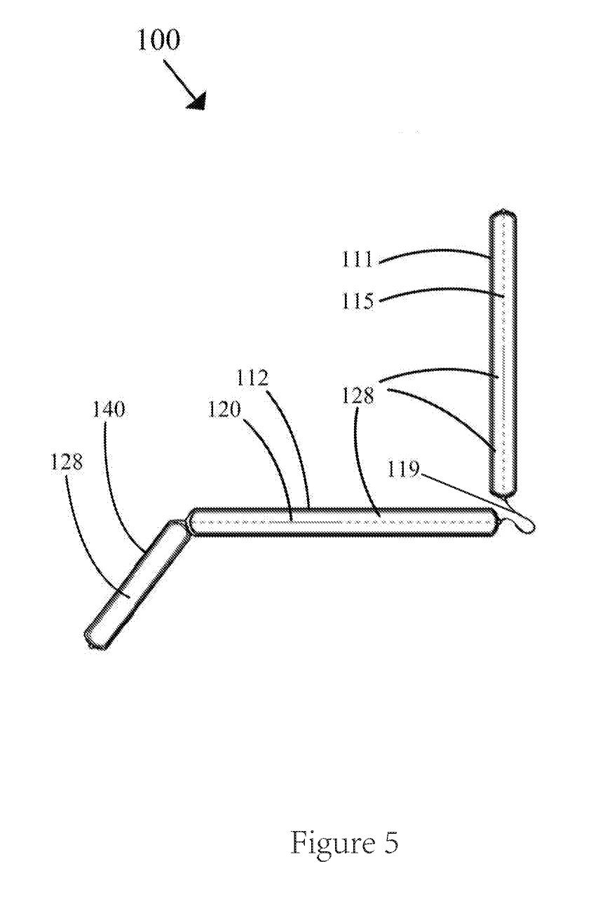

FIG. 5 shows a cross-sectional view of alternative embodiment of wheelchair seat cushion 100 according to the present invention. Wheelchair seat cushion 100 comprises back pad module 111 and seat pad module 112. Back pad module 11 and seat pad module 12 are connected by at least one flexible connector, for example, two flexible bands 119. Back pad module 111 and seat pad module 112 are provided with resilient intermediate layer 128, which is made of a material with strong support and high air-permeability, such as resin cotton.

Heat generating device 115 is provided within in resilient intermediate layer 128 of back pad module 111 and is positioned at a lower portion of back pad module 111 for supplying heat to the back of the user. In one embodiment, heat generating device 15 is positioned corresponding to at least one acupuncture point of a back of a user, for example Mingmen point and Shenshu point located at the back of the user. Heat generating device 120 is provided within in resilient intermediate layer of seat pad module 112. Heat generating device 120 is positioned corresponding to thigh portions close to knees of the user. Both heat generating device 115 and 120 have thermostats and power ports, like thermostats 17, 22 and power ports 16, 21 (not shown in the drawings)

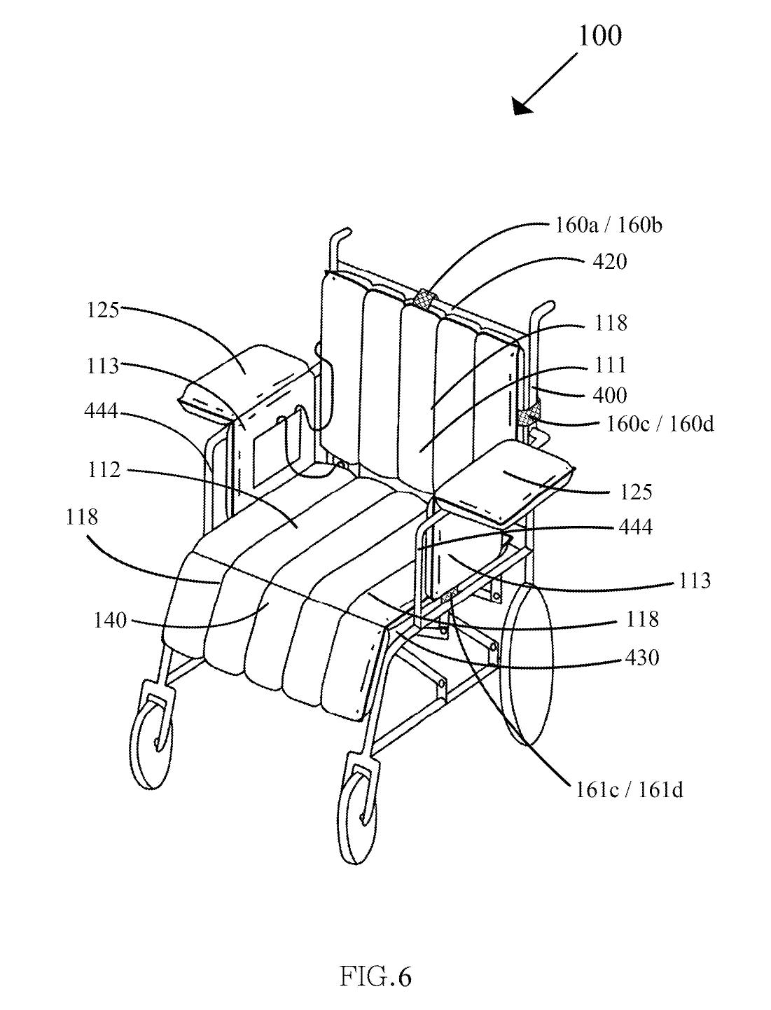

FIG. 6 is a schematic view of wheelchair seat cushion 100 on a wheelchair 400 in a use configuration. A plurality of fold lines 118 are provided on surfaces of back pad module 111 and seat pad module 112 respectively. Back pad module 111 is secured onto back frame 420 of wheelchair 400 by fasteners 160a, 160b, 160c and 160d located at front end, rear end, both sides of back pad module 111, for example, hooks and loops. Seat pad module 112 is secured onto back frame 430 of wheelchair 400 by fasteners 161a, 161b, 161c and 161d located at front end, rear end, both sides of seat pad module 112, for example, hooks and loops.

Wing modules 113 extend outwardly from both sides of seat pad module 112 respectively. When the user uses the wheelchair 400, there is a gap between knee portions of the user and wheelchair 400. Muscles will become tense, tired and/or sore due to lack of physical support at the knee portions for long time. Leg pad module 140 is used to support knee portions and leg portions of the user. Leg pad module 140 is disposed at one end of seat pad module 112, which is opposite to the other end connected with back pad module 111. The leg pad module 140 is provided with resilient intermediate layer 128, which is made of a material with strong support and high air-permeability, such as resin cotton. Leg pad module 140 is enclosed by a waterproof material, such as a nylon material. A plurality of fold lines 118 are provided on a surface of leg pad module 140.

In one embodiment, foldable armrest pad module 125 is provided at a top end of wing module 113. When wheelchair seat cushion 100 is used on the wheelchair 400, armrest pad module 125 opens and lays flat on handle portion 444 of wheelchair 400, so that the user is able to place his/her arm on the armrest pad module 125 for relaxing. Similarly, a foldable armrest pad module may be available at a top end of wing module 13.

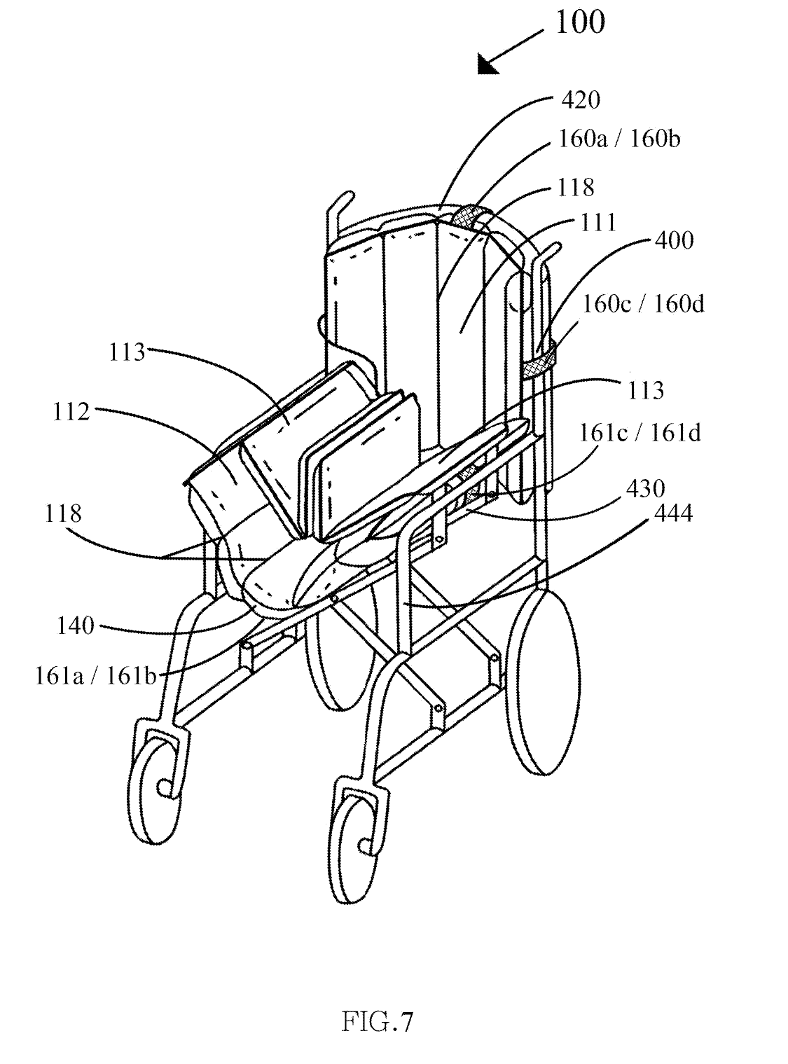

FIG. 7 illustrates that wheelchair 400 with wheelchair seat cushion 100 is in a folded configuration. Leg pad module 140 is folded about the end of seat pad module 112 and then is disposed under seat pad module 112. While wheelchair 400 is being folded, back cushion module 111, seat pad module 12 and leg pad module 140 are concurrently being folded via the plurality of fold lines 118. One of the benefits is to allowing the user to fold wheelchair 40 and wheelchair seat cushion 100 at the same time, instead of removing wheelchair seat cushion 10 and then folding wheelchair 400.

The embodiments of the present invention are described above with reference to the accompanying drawings. However, the present invention is not limited to the above specific embodiments. The foregoing specific embodiments are merely illustrative and not intended to limit the present invention. In the light of the present invention, many forms can be made without departing from the spirit and the scope of the claims of the present invention, which all belong to the protection of the present invention.

What is claimed is:

1. A wheelchair seat cushion comprising
a back-pad module;
a seat pad module connected with the back pad module;
a resilient intermediate layer provided within the back-pad module and the seat pad module;
a heat generating device provided within in the resilient intermediate layer, wherein the heat generating device is positioned corresponding to at least one acupuncture point of a back of a user, and heat generated by the heat generating device is conducted to a body of the user via the at least one acupuncture point in order to keep the body of the user warm.

2. The wheelchair seat cushion of claim 1, wherein the back pad module and the seat pad module are connected via at least one flexible band.

3. The wheelchair seat cushion of claim 1, wherein surfaces of the back pad module and the seat pad module have a plurality of fold lines, by which the user folds the seat cushion and a wheelchair concurrently.

4. The wheelchair seat cushion of claim 1, wherein the heat-generating device is positioned corresponding to Mingmen point and Shenshu point of the back of the user.

5. The wheelchair seat cushion of claim 4, wherein the resilient intermediate layer is made of resin cotton so as to enhance support and air permeability of the wheelchair seat cushion.

6. The wheelchair seat cushion of claim 5, wherein the back pad module has wing modules extending outwardly from both sides thereof respectively or the seat pad module has wing modules extending outwardly from both sides thereof respectively, to protect both chest sides of the user.

7. The wheelchair seat cushion of claim 6, wherein the wing module is foldable about the side of the back pad module or the wing module is foldable about the side of the seat pad module.

8. The wheelchair seat cushion of claim 7, wherein a top end of the wing module has an armrest pad module so that the user places his/her arm on the armrest pad module.

9. The wheelchair seat cushion of claim 8, wherein a heat generating device is provided within in the seat pad cushion module to keep thigh portions of the user warm.

10. The wheelchair seat cushion according to claim 9, further comprising a leg pad module attached to one side of the seat pad module opposite to the back pad module.

11. The wheelchair seat cushion according to claim 10, wherein a surface of the leg pad module is provided with a plurality of fold lines.

12. The wheelchair seat cushion according to claim 11, wherein the back-pad module comprises at least one fastener to secure the back pad module on the wheelchair.

13. The wheelchair seat cushion according to claim 11, wherein the seat pad module comprises at least one fastener to secure the seat pad module on the wheelchair.

14. The wheelchair seat cushion according to claim 11, wherein the back pad module, seat pad module and/or wing module are enclosed by a waterproof material.

15. The wheelchair seat cushion according to claim 14, wherein the waterproof material is a nylon material.
